(19) United States
(12) Patent Application Publication
(10) Pub. No.: US 2011/0038544 A1
(43) Pub. Date: Feb. 17, 2011

(54) IMAGE PROCESSING DEVICE, IMAGE PROCESSING METHOD, AND ELECTRONIC APPARATUS

(75) Inventors: Taketoshi SEKINE, Shizuoka (JP); Munekatsu Fukuyama, Tokyo (JP); Nobuhiro Saijo, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/837,837

(22) Filed: Jul. 16, 2010

(30) Foreign Application Priority Data
Aug. 12, 2009 (JP) 2009-187047

(51) Int. Cl. G06K 9/46; H04N 9/68

(52) U.S. Cl. 382/190; 348/234; 348/E09.053

(57) ABSTRACT

An image processing device detecting a skin area representing the skin of a person from an image obtained by imaging an object, includes: imaging means for imaging the object; first illumination means for radiating light having a first wavelength from first and second positions determined based on the position of the imaging means; second illumination means for radiating light having a second wavelength different from the first wavelength from third and fourth positions determined based on the position of the imaging means; and detection means for detecting the skin area on either a first image obtained through imaging of the object performed by illuminating the object with the light having the first wavelength or a second image obtained through imaging of the object performed by illuminating the object with the light having the second wavelength.

### BACKGROUND OF THE INVENTION

1. Field of the Invention

The present invention relates to an image processing device, an image processing method, and an electronic apparatus. More particularly, the invention relates to an image processing device, image processing method, and electronic apparatus in which non-coincidence between illuminance distributions of light sources having different wavelength can be suppressed with a simple configuration.

2. Background of the Related Art

In the related art, there are detection devices which detect a certain characteristic of an object (e.g., a person) from an image obtained by imaging the object.

For example, such a detection device is used a digital camera. Thus, such a digital camera detects the face of a person from a through image for composing a picture, and a shutter operation is enabled, for example, when the detected face is smiling.

Further, some digital cameras detect the face of a person from an image obtained by, for example, imaging the person and correct a blur or the like present in the detected face region based on the detection result.

Further, some television receivers detect a body motion or hand motion of a person from an image obtained by, for example, imaging the person with a camera incorporated therein and switch the broadcast channel to receive.

Furthermore, there are analyzers which analyze an object illuminated by illumination light rays based on, for example, light rays reflected by the object when the object is illuminated with the illumination light rays which have respective different wavelengths (for example, see JP-A-2006-47067, JP-A-06-123700 and JP-A-05-329163 (Patent Documents 1 to 3)).

An image processing device 1 according to the related art will now be descried as an example of such an analyzer. The image processing device 1 detects a skin area representing the skin of a person based on images including the skin area imaged by receiving light rays reflected from the object when the object is illuminated by respective illumination light rays having different wavelengths.

FIGS. 1A and 1B show an exemplary configuration of the image processing device 1 according to the related art.

FIG. 1A is a plan view of the image processing device 1 taken from a point on a Z-axis, and FIG. 1B is a perspective view of the image processing device 1.

The image processing device 1 includes a camera 21, a light source 22, another light source 23, and an image processing section 24 as major elements.

The camera 21 images an object and supplies the image thus obtained to the image processing section 24. The light source 22 may be an LED (light emitting diode), and it radiates (emits) light having a wavelength λ1 (for example, a near infrared ray having a wavelength of 870 nm). The light source 23 may be al LED, and it radiates light having a wavelength λ2 different from the wavelength λ1 (for example, a near infrared ray having a wavelength of 950 nm). The image processing section 24 detects a skin area on images imaged by the camera 21 and performs processes based on results of the detection.

In the image processing device 1 according to the related art, the light sources 22 and 23 are switched to emit light alternately, and the camera 21 obtains a first image by imaging an object when the object is illuminated by illumination light having the wavelength λ1 and obtains a second image by imaging the object when the object is illuminated by illumination light having the wavelength λ2.

The image processing section 24 calculates absolute differences between luminance values of pixels corresponding between the first and second images imaged by the camera 21 and detects a skin area in the first image (or the second image) based on the calculated absolute differences.

In general, the reflectance at which the illumination light of the wavelength λ1 is reflected on human skin is lower than the reflectance at which the illumination light of the wavelength λ2 is reflected on human skin. Therefore, the absolute differences between the luminance values of the pixels forming the skin area in the first and second images have relatively great values.

The reflectance at which the illumination light of the wavelength λ1 is reflected on an object other than human skin is substantially the same as the reflectance at which the illumination light of the wavelength λ2 is reflected on the object other than human skin. Thus, absolute differences between the luminance values of the pixels forming the area in the first and second images other than the skin area have relatively small values.

Therefore, the image processing section 24 of the image processing device 1 can detect an area of interest as a skin area, for example, when absolute differences as thus described have relatively great values.

In order to allow the image processing device 1 to detect a skin area in the first image accurately, an illuminance distribution on the object obtained by the illumination light having the wavelength λ1 must coincide with an illuminance distribution on the object obtained by the illumination light having the wavelength λ2.

Let us assume that the light sources 22 and 23 of the image processing device 1 coincide with each other in terms of directivity (there is no variation in directivity). Then, even if the illuminance distributions obtained by the light rays having the wavelengths λ1 and λ2 do not coincide with each other, the non-coincidence between the illuminance distributions can be mitigated using simple methods such as multiplying each of the first and second images by a uniform luminance correction factor.

Therefore, when the light sources 22 and 23 of the image processing device 1 coincide with each other in terms of directivity, it is possible to prevent absolute differences as described above from being calculated at relatively great values due to non-coincidence between illuminance distributions.

Light sources manufactured as the same production lot (substantially) coincide with each other in terms of directivity (a production lot is a unit of light sources of the same type manufactured at the same place and time using the same method).

However, the light sources 22 and 23 are different types of light sources. Therefore, the light sources 22 and 23 cannot be manufactured in the same production lot.

Therefore, in order to use light sources 22 and 23 in coincidence with each other in directivity in the image processing device 1, the directivity of each of light sources 22 and 23 must be checked, and screening must be carried out to obtain each pair of light sources 22 and 23 in coincidence with each other in terms of directivity as light sources to be used in an image processing device 1.

Although the image processing device 1 is capable of detecting a skin area in the first image with relatively high accuracy because it employs the light sources 22 and 23 in coincidence with each other in directivity, it has been required to screen light sources to obtain a pair of light sources 22 and 23 in coincidence with each other in terms of directivity to be used in the image processing device.

Let us assume that the light sources 22 and 23 of the image processing device 1 are different in directivity (there is variation of directivity). Then, when the illuminance distributions of the light rays having the wavelengths λ1 and λ2 do not coincide with each other, there is no simple method for preventing absolute differences between pixel values from being calculated at relatively great values because of the non-coincidence between the illuminance distributions.

Therefore, when the light sources 22 and 23 are different in directivity, it is not possible to identity the cause of resultant absolute differences, i.e., whether the differences are attributable to reflectivity characteristics associated with the wavelengths λ1 and λ2 respectively or are attributable to non-coincidence between the illuminance distributions.

As a result, an area of the first image associated with absolute differences having relatively great values can be detected as a skin area by mistake, for example, even though the absolute differences have been calculated at relatively great values because of non-coincidence between illuminance distributions.

Therefore, in order to allow the image processing device 1 to detect a skin area on a first image to be accurately even when the light sources 22 and 23 are not coincidence with each other in terms of directivity, the illuminance distribution of light having the wavelength λ1 and the illuminance distribution of light having the wavelength λ2 must be made to coincide with each other.

Meanwhile, there are equalization techniques for equalizing illuminance distributions of illumination light illuminating an object to be imaged such as a hand of a user.

Such equalization techniques include a first equalization technique according to which, for example, a plurality of light sources radiating illumination light rays having the same wavelengths are disposed to surround an object to be imaged such as a hand of a user as shown in FIG. 2. Thus, the object is illuminated by the illumination light rays having the same wavelength from the plurality of light sources.

There is a second equalization technique according to which, for example, light sources radiating illumination light having a wavelength λ1 and light sources radiating light having a wavelength λ2 are alternately disposed so as to face an object to be imaged, as shown in FIG. 3. Thus, the object is illuminated by the illumination light having the wavelength λ1 and the illumination light having the wavelength λ2 separately.

### SUMMARY OF THE INVENTION

According to the first equalization technique according to the related art shown in FIG. 2, since a plurality of light sources are disposed to surround an object to be imaged, the generation of shadows on the object to be imaged is suppressed, and illuminance distributions on the object to be imaged can be equalized to some degree. However, the approach reflects no consideration on the use of light sources having a plurality of wavelengths, and it is not possible to suppress non-coincidence between illuminance distributions of light rays having wavelengths λ1 and λ2, respectively.

According to the second equalization technique according to the related art shown in FIG. 3, since light sources radiating illumination light having a wavelength λ1 and light sources radiating illumination light having a wavelength λ2 are alternately disposed, the intensity of illumination light rays radiated from each group of light sources can be equalized (averaged) to eliminate variation of the intensity. However, non-coincidence between illuminance distributions of light rays having the wavelengths λ1 and λ2 cannot be suppressed depending on the distance between the light sources and the object to be imaged.

Thus, it is desirable to suppress non-coincidence between illuminance distributions of light rays having different wavelengths with a simple configuration.

According to an embodiment of the invention, there is provided an image processing device detecting a skin area representing the skin of a person from an image obtained by imaging an object. The device includes imaging means for imaging the object, first illumination means for radiating light having a first wavelength from first and second positions determined based on the position of the imaging means, second illumination means for radiating light having a second wavelength different from the first wavelength from third and fourth positions determined based on the position of the imaging means, and detection means for detecting the skin area on either a first image obtained through imaging of the object performed by illuminating the object with the light having the first wavelength or a second image obtained through imaging of the object performed by illuminating the object with the light having the second wavelength.

The first illumination means may include first output means for radiating light having the first wavelength in the first position and second illumination means for radiating light having the first wavelength in the second position. Each of the first and second output means may be tilted toward a reference axis of the imaging means.

The first and second output means may be provided in a tilted disposition in the first and second positions, respectively, in such a positional relationship that the output means are symmetric about the reference axis of the imaging means.

Each of the first and second output means may be tilted toward the reference axis of the imaging means at a predetermined tilt angle.

Either of the first and second output means may be provided in the first position in a tilted disposition, and the other output means may be provided in the second position in a tilted disposition, the second position being spaced from the first position at a distance which depends on the predetermined tilt angle.

The second illumination means may include third output means for radiating light having the second wavelength in third position and fourth illumination means for radiating light having the second wavelength in the fourth position. Each of the third and fourth output means may be tilted toward the reference axis of the imaging means.

The first and third output means may be provided in the tilted disposition in positions close to each other, and the second and fourth output means may be provided in the tilted disposition in positions close to each other.

The first and second illumination means may radiate light of the first and second wavelengths set at such values that an absolute difference between the reflectance of reflected light obtained by illuminating the skin of a person with light having the first wavelength and the reflectance of reflected light obtained by illuminating the skin of the person with light having the second wavelength is equal to or greater than a predetermined threshold.

The first and second illumination means may radiate respective infrared rays having different wavelengths.

Either of the first and second illumination means may radiate light having a wavelength of 930 nm or more, and the other illumination means may radiate light having a wavelength less than 930 nm.

According to another embodiment of the invention, there is provided an image processing method of an image processing device for detecting a skin area representing the skin of a person from an image obtained by imaging an object, including imaging means, first illumination means, second illumination means, and detection means. The method includes the steps of radiating light having a first wavelength from the first illumination means in first and second positions determined based on the position of the imaging means, radiating light having a second wavelength different from the first wavelength from the second illumination means in third and fourth positions determined based on the position of the imaging means, imaging the object with the imaging means by illuminating the object with the light having the first wavelength and the light having the second wavelength, and detecting the skin area on either a first image obtained through the imaging of the object performed by illuminating the object with the light having the first wavelength or a second image obtained through the imaging of the object performed by illuminating the object with the light having the second wavelength.

According to the embodiments of the invention, a skin area is detected on either a first image or a second image obtained by imaging an object. The first image is obtained by imaging the object through illumination of the object with light having a first wavelength from first and second positions determined based on the position of imaging means. The second image is obtained by imaging the object through illumination of the object with light having a second wavelength different from the first wavelength from third and fourth positions determined based on the position of imaging means.

According to still another embodiment of the invention, there is provided an electronic apparatus detecting a skin area representing the skin of a person from an image obtained by imaging an object. The apparatus includes imaging means for imaging the object, first illumination means for radiating light having a first wavelength from first and second positions determined based on the position of the imaging means, second illumination means for radiating light having a second wavelength different from the first wavelength from third and fourth positions determined based on the position of the imaging means, detection means for detecting the skin area on either a first image obtained through imaging of the object performed by illuminating the object with the light having the first wavelength or a second image obtained through imaging of the object performed by illuminating the object with the light having the second wavelength, and processing means for performing a process associated with the detected skin area.

According to the embodiment of the invention, a skin area is detected on either a first image or a second image obtained by imaging an object, and a process associated with the detected skin area is performed. The first image is obtained by imaging the object through illumination of the object with light having a first wavelength from first and second positions determined based on the position of imaging means. The second image is obtained by imaging the object through illumination of the object with light having a second wavelength different from the first wavelength from third and fourth positions determined based on the position of imaging means.

According to the embodiments of the invention, non-coincidence between illuminance distributions obtained using light sources having different wavelengths can be suppressed using a simple configuration. As a result, it is possible to improve the accuracy of detection of an object (e.g., a skin area such as the face or hand of a person or a predetermined action of the person) from an image obtained by imaging the object.

### BRIEF DESCRIPTION OF THE DRAWINGS

FIGS. 1A and 1B are illustrations showing an exemplary configuration of an image processing device according to the related art;

FIG. 2 is an illustration for explaining a first equalization technique;

FIG. 3 is an illustration for explaining a second equalization technique;

FIG. 4 is a block diagram showing an exemplary configuration of an image processing device which is an embodiment of the invention;

FIG. 5 is a first illustration for explaining the disposition of light source groups;

FIG. 6 is a second illustration for explaining the disposition of light source groups;

FIG. 7 is a graph associated with an illuminance ratio variation index;

FIG. 8 is a graph associated with a luminous quantity index;

FIG. 9 is a third illustration for explaining the disposition of light source groups; and

FIG. 10 is a fourth illustration for explaining the disposition of light source groups.

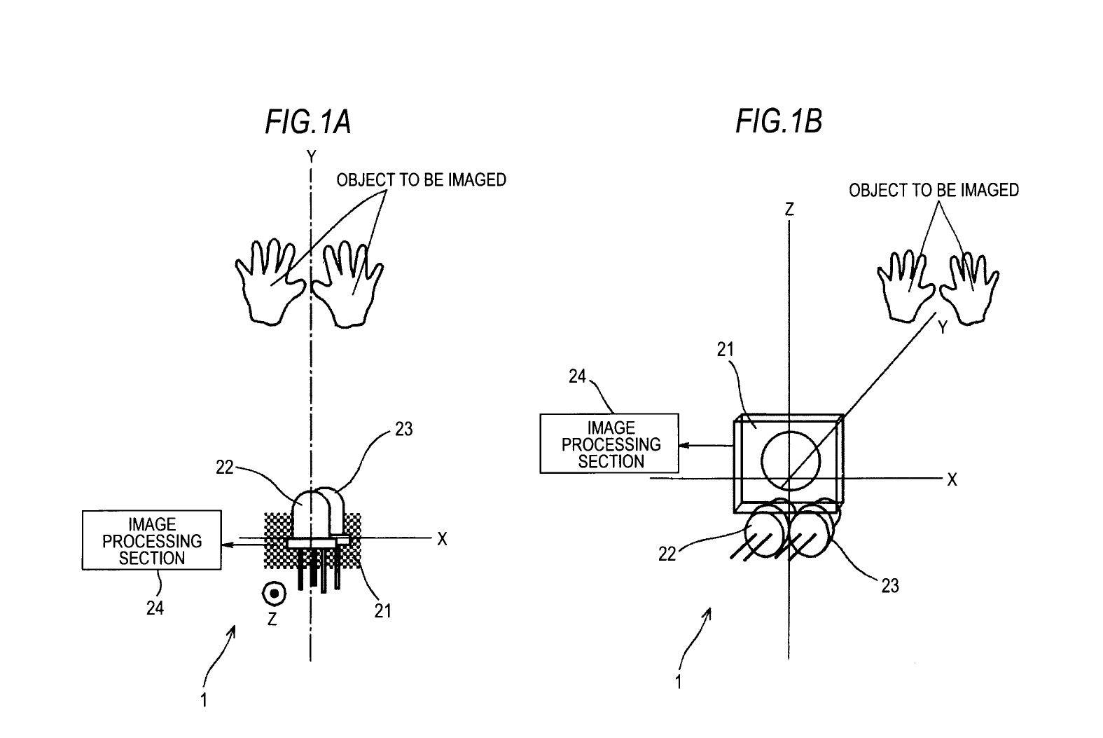

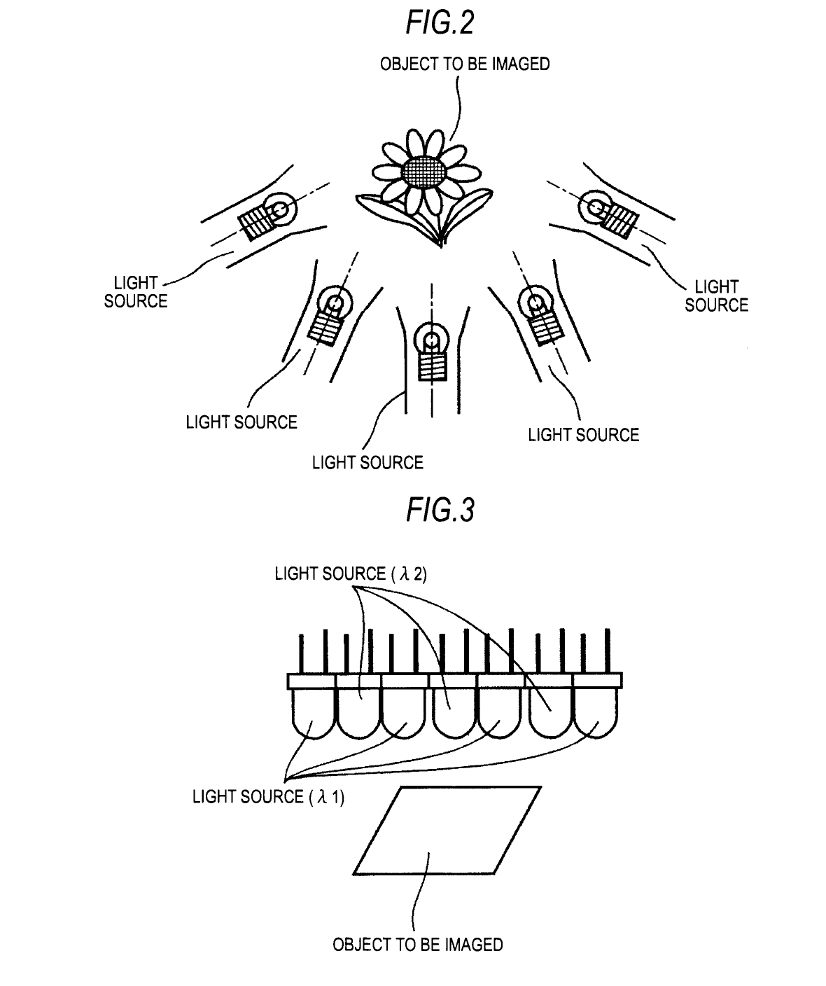

### DESCRIPTION OF PREFERRED EMBODIMENTS

Modes for implementing the invention (hereinafter referred to as embodiment) will now be described in the following order.

1. Embodiment (Example in which light sources are provided in a tilted disposition)

2. Modification

### 1. Embodiment

### Configuration of Image Processing Device 41

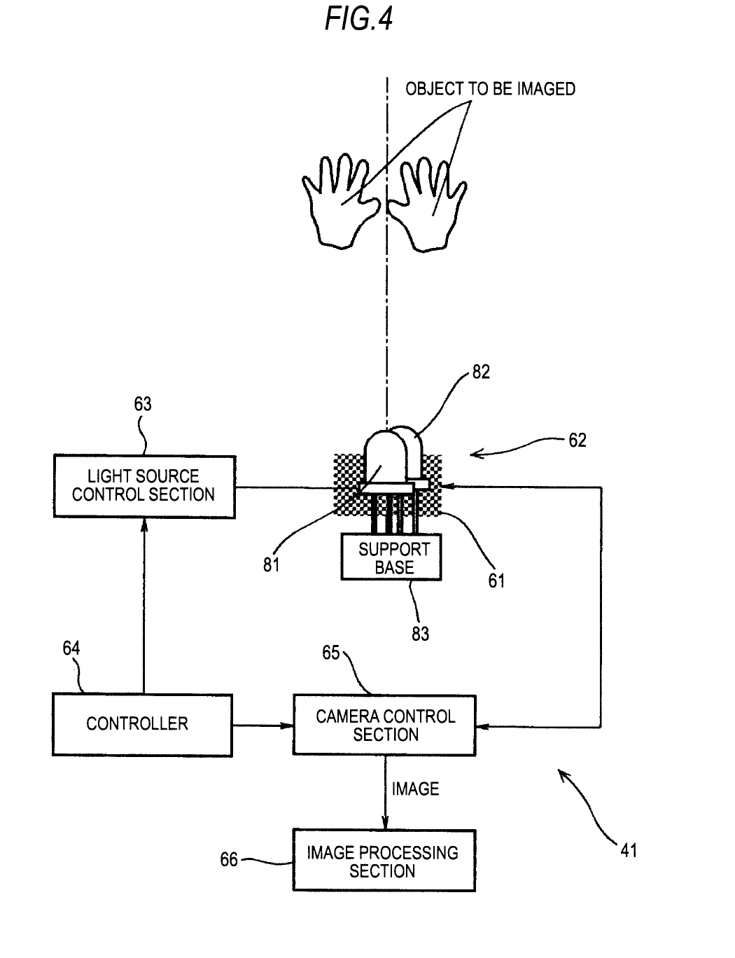

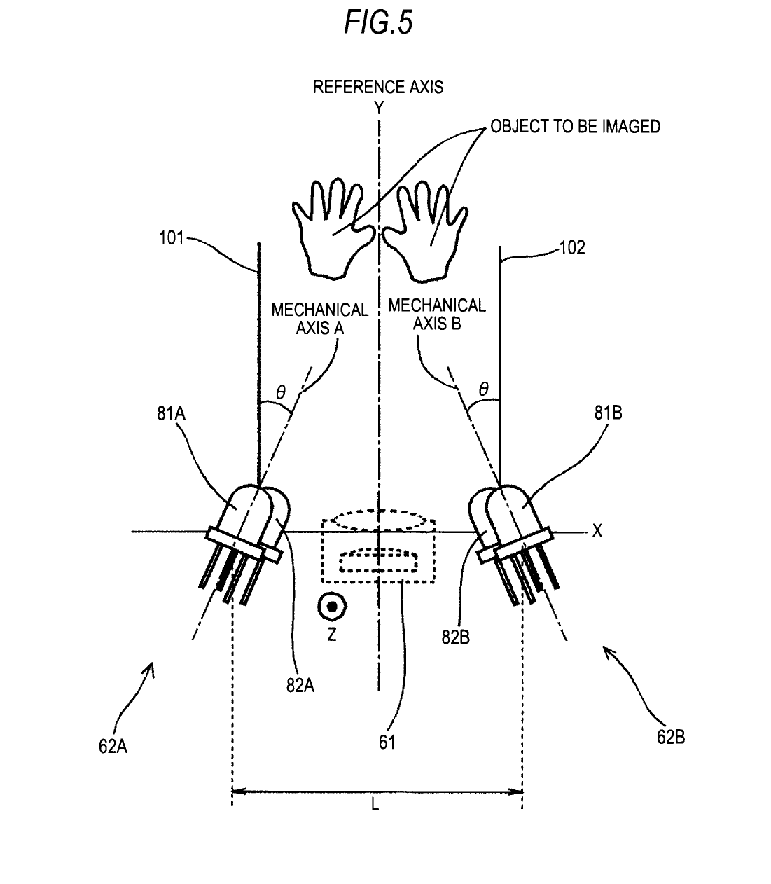

FIG. 4 shows an exemplary configuration of an image processing device 41 according to an embodiment of the invention.

The image processing device 41 includes a camera 61, light source groups 62, a light source control section 63, a controller 64, a camera control section 65, and an image processing section 66.

The camera 61 images an object (object to be imaged) and supplies an image obtained by imaging the object to the camera control section 65.

The light source groups 62 include a light source 81, another light source 82, and a support base 83. For example, the light source 81 is an LED, and the light source radiates illumination light having a wavelength λ1 (e.g., near infrared light having a wavelength of 870 nm). For example, the light source 82 is an ELD, and the light source radiates illumination light having a wavelength λ2 which is different from the wavelength λ1 (e.g., near infrared light having a wavelength of 950 nm). The support base 83 supports the light sources 81 and 82 such that an object to be imaged is illuminated by illumination light radiated by the light sources 81 and 82.

The image processing device 41 includes a plurality of light source groups 62. The number of the light source groups 62 disposed and the positions of the light source groups will be described later with reference to FIGS. 5, 6, and 10 which will be described later.

The light source control section 63 controls the light source 81 to cause it to radiate illumination light having the wavelength λ1. The light source control section 63 also controls the light source 82 to cause it to radiate illumination light having the wavelength λ2. The controller 64 controls the light source control section 63 and the camera control section 65. In response to the control by the controller 64, the camera control section 65 controls the imaging by the camera 61. The camera control section 65 supplies an image imaged by the camera 61 to the image processing section 66.

The image processing section 66 detects, for example, a skin area included in the image supplied from the camera control section 65. The image processing section 66 performs processes associated with the detected skin area.

### Disposition of Two Light Source Groups 62

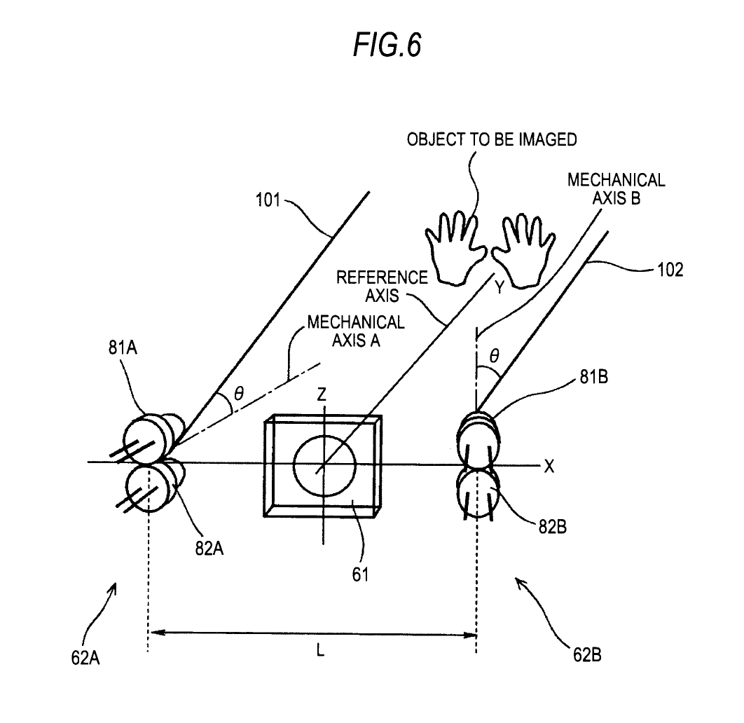

An example of the disposition of the light source groups 62 will be described with reference to FIGS. 5 and 6.

FIG. 5 is a plan view of the image processing device 41 taken from a point on a Z-axis, and FIG. 6 is a perspective view of the image processing device 41.

In order to avoid complicatedness of illustration, FIGS. 5 and 6 show only the camera 61 and the light sources 81 and 82 (of the light source groups 62), and the light source control section 63, the controller 64, the camera control section 65, the image processing section 66, and the support base 83 are omitted in the illustration.

Referring to FIGS. 5 and 6, two light source groups 62A and 62B are used as the light source groups 62.

The camera 61 is disposed on the origin of an XYZ coordinate system such that a reference axis of the camera 61 coincides with the Y-axis. The reference axis is an imaginary line which extends in the normal direction of a lens surface of the camera 61 (the imaging direction of the camera 61) and which extends through the center of the lens surface (the so-called optical axis of the lens).

The light source group 62A is constituted by a light source 81A radiating illumination light having the wavelength λ1 and a light source 82A radiating illumination light having the wavelength λ2. The light source group 62B is constituted by a light source 81B radiating illumination light having the wavelength λ1 and a light source 82B radiating illumination light having the wavelength λ2.

The light source groups 62A and 62B are disposed in such positions on the XZ plane defined by the X-axis and the Z-axis that the light source groups are symmetric about the reference axis of the camera 61 (Y-axis).

The term “symmetric” in this context is used to represent a situation in which the light source groups 62A and 62B are disposed point-symmetrically about the reference axis of the camera 61 acting as the axis of symmetry (i.e., disposed point-symmetrically about the origin of the XYZ coordinate system where the reference axis of the camera 61 and the XZ plane intersect each other) or a situation in which the light source groups 62A and 62B are disposed line-symmetrically about a straight line which orthogonally intersects the reference axis of the camera 61 (Y-axis) and which also orthogonally intersects the X-axis, the straight line (i.e., the Z-axis) serving as an axis of symmetry.

Further, the light source 81A of the light source group 62A is disposed in such a position that a mechanical axis A of the light source 81A extends through an object to be imaged. The mechanical axis A is an axis extending through the light source 81A substantially in the middle thereof and extending in parallel with the direction in which a maximum illuminance distribution is obtained.

Similarly, the light source 82A is disposed in such a position that a mechanical axis of the light source 82A extends through the object to be imaged.

The light source 81B of the light source group 62B is disposed in such a position that a mechanical axis B of the light source 81B extends through the object to be imaged. The mechanical axis B is an axis extending through the light source 81B substantially in the middle thereof and extending in parallel with the direction in which a maximum illuminance distribution is obtained.

Similarly, the light source 82B is disposed in such a position that a mechanical axis of the light source 82B extends through the object to be imaged.

Referring to FIGS. 5 and 6, a tilt angle θ (deg) is an angle at which the mechanical axis A is tilted toward the Y-axis (an angle defined by a line segment 101 in parallel with the Y-axis and the mechanical axis A), an angle at which the mechanical axis of the light source 82A is tilted toward the Y-axis, an angle at which the mechanical axis B is tilted toward the Y axis (an angle defined by a line segment 102 in parallel with the Y-axis and the mechanical axis B), or an angle at which the mechanical axis of the light source 82B is tilted toward the Y-axis.

The light source groups 62A and 62B are disposed such that the mechanical axes of the light sources 81A, 81B, 82A, and 82B are tilted toward the Y-axis at the same tilt angle θ (tilted disposition).

The distance L[m] in FIGS. 5 and 6 is the distance between the light source groups 62A and 62B.

The tilt angle θ is set within the range from about 3 deg to about 45 deg. The distance L is set according to the set tilt angle θ such that each of the mechanical axes extends through the object to be imaged at that angle.

Such a configuration is adopted because an experiment carried out by the inventors revealed that tilt angles θ set within the range from about 3 deg to about 45 deg provide relatively good results.

### Outline of Experiment

The experiment carried out by the inventors will now be briefly described.

The inventors carried out an experiment on the image processing device 41 having the light source groups 62A and 62B. Specifically, an illuminance ratio variation index α and a luminous quantity index β were calculated for each of combinations (θ, L) of the tilt angle θ and the distance L at which the light source groups 62A and 62B were disposed such that the respective mechanical axes would extend through an object to be imaged.

The illuminance ratio variation index α is an index indicating the degree of coincidence between illuminance distributions of light rays having the wavelengths λ1 and λ2. The luminous quantity index β is an index which is proportionate to the luminous quantity of illumination light illuminating an object to be imaged. The illuminance ratio variation index α and the luminous quantity index β will be described later in detail.

In this experiment, a camera having a field angle of 29.6 deg in the X-axis direction (horizontal direction) and a field angle of 22.4 deg in the Z-axis direction (vertical direction) was used as the camera 61. Further, LEDs emitting (radiating) illumination light) at an emission angle of 16 deg were used as the light sources 81A and 81B, and LEDs having an emission angle of 21 deg were used as the light sources 82A and 82B.

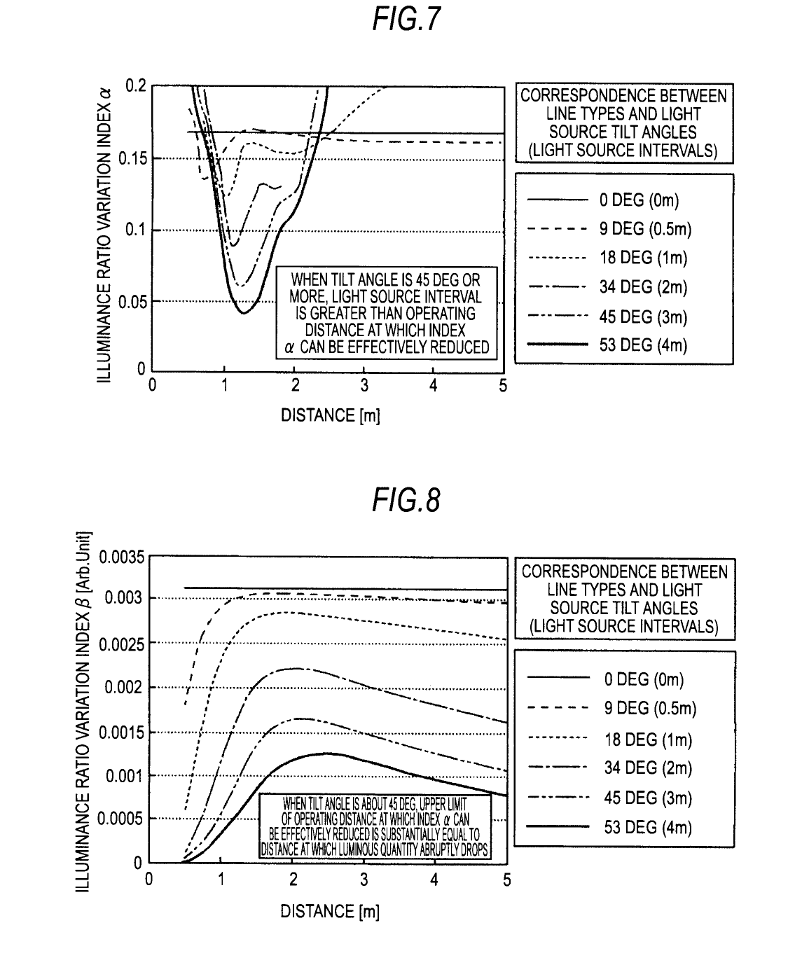

Results of the experiment carried out by the inventors will now be detailed with reference to FIGS. 7 and 8.

### Relationship Between Tilt Angle θ And Illuminance Ratio Variation Index α

FIG. 7 shows a relationship between the tilt angle θ and the illuminance ratio variation index α.

In FIG. 7, the horizontal axis represents the distance from the camera 61 to the object to be imaged, and the vertical axis represents the illuminance ratio variation index α are shown.

An illuminance ratio variation index α is a maximum value max|(I1−I2)/ave| among absolute values of a plurality of quotients |(I1−I2)/ave| where (I1−I2) represents differences (I1−I2) between pixel values I1 of pixels forming a first image obtained by imaging the object and pixel values I2 of pixels forming a second image obtained by imaging the object and corresponding to the pixels of the first image and where “ave” represents an average of luminance values of the pixels forming the first and second images.

Great and small absolute values |(I1−I2)/ave| are calculated with greater differences in magnitude at higher scatterdness, the higher the degree of non-coincidence between the illuminance distributions of interest. Values calculated as absolute values |(I1−I2)/ave| are smaller, the higher the degree of coincidence between the illuminance distributions.

Therefore, the maximum value max |(I1−I2)/ave| is smaller (closer to 0), the higher the coincidence between the illuminance distributions.

The curve represented in a thin line (thin solid line) in FIG. 7 is a plot obtained when the combination (θ, L) is (0, 0). The curve represented in a dotted line is a plot obtained when the combination (θ, L) is (9, 0.5).

The curve represented in a finer dotted line (dotted line formed by a greater number of dots) is a plot obtained when the combination (θ, L) is (18, 1). The curve represented in a chain line is a plot obtained when the combination (θ, L) is (34, 2).

The curve represented in a two-dot chain line is a plot obtained when the combination (θ, L) is (45, 3). The curve represented in a thick (thick solid line) is a plot obtained when the combination (θ, L) is (53, 4).

As shown in FIG. 7, the illuminance ratio variation index α is closer to 0, the greater the tilt angle θ. That is, the degree of coincidence between illuminance distributions is higher, the greater the tilt angle θ.

The degree of coincidence between illuminance distributions increases with the tilt angle θ for the reason described below.

The distance between the light source groups 62A and 62B of the image processing device 41 and an object to be imaged increases with the tilt angle θ. Illumination light radiated from the light source 81A in a direction parallel to the mechanical axis A illuminates the object to be imaged with a more uniform optical intensity, the greater the distance between the light source and the object. Similarly, illumination light radiated from the light source 82A in a direction parallel to the mechanical axis thereof illuminates the object to be imaged with a more uniform optical intensity, the greater the distance between the light source and the object.

Illumination light radiated from the light source 81B in a direction parallel to the mechanical axis B illuminates the object to be imaged with a more uniform optical intensity, the greater the distance between the light source groups 62A and 62B and the object. Similarly, Illumination light radiated from the light source 82B in a direction parallel to the mechanical axis thereof illuminates the object to be imaged with a more uniform optical intensity, the greater the distance between the light source groups 62A and 62B and the object.

That is, illumination light having the wavelength λ1 radiated from the light sources 81A and 81B at certain timing has a more uniform optical intensity, the greater the distance between the light source groups 62A and 62B and the object to be imaged. Illumination light having the wavelength λ2 radiated from the light sources 82A and 82B at different timing has a more uniform optical intensity, the greater the distance between the light source groups 62A and 62B and the object to be imaged.

In this case, the illumination light of the wavelength λ1 having a uniform optical intensity is radiated to obtain a uniform illuminance distribution by the light having the wavelength λ1 at the first timing. At the different or second timing, the illumination light of the wavelength λ2 having a uniform optical intensity is radiated to obtain a uniform illuminance distribution by the light having the wavelength λ2.

Therefore, the illuminance distribution of the light having the wavelength λ1 and the illuminance distribution of the light having the wavelength λ2 are more uniform, the greater the distance between the light source groups 62A and 62B and the object to be imaged (the greater the tilt angle θ). Thus, non-coincidence between the illuminance distributions of the light rays having the wavelengths λ1 and λ2 can be more effectively suppressed (a higher degree of coincidence can be achieved between the illuminance distribution, the greater the distance.

### Relationship Between Tilt Angle θ And Luminous Quantity Index β

FIG. 8 shows a relationship between the tilt angle θ and the luminous quantity index β.

In FIG. 8, the horizontal axis represents the distance from the camera 61 to an object to be imaged. The vertical axis of the figure represents the luminous quantity index β.

The luminous quantity index β is an index which is proportionate to a total luminous quantity obtained by integrating quantities of light radiated to an imaging range of the camera 61 (a range which includes the object to be imaged).

FIG. 8 shows curves obtained by various combinations (θ, L) of the tilt angle θ and the distance L in the same manner as in FIG. 7.

As shown in FIG. 8, as the tilt angle θ increases, the distance L and the distance between the object to be imaged and each of the light source groups 62A and the light source group 62B increase. Therefore, the luminous quantity index β decreases as the tilt angle θ increases. That is, the luminous quantity of illumination light illuminating the object to be imaged (imaging range) decreases, as the tilt angle θ increases.

Referring to FIG. 7, when the distance from the camera 61 to the object to be imaged (represented by the horizontal axis of the figure) is about 1.5 m, the illuminance ratio variation index α has a relatively small value regardless of the combination (θ, L) used.

Referring to FIG. 8, when the distance from the camera 61 to the object to be imaged is in the range from about 1.5 m to about 1.8 m, the luminous quantity index β has a relatively great value regardless of the combination (θ, L) used.

An experiment was conducted with the distance from the camera 61 to an object to be imaged set at 1.5 m to find a tilt angle θ at which illuminance distributions of illumination light rays having the wavelengths λ1 and λ2 illuminating the object have a high degree of coincidence and at which the illumination light rays have a great luminous quantity to allow a skin area to be accurately detected from a first image obtained by imaging the object.

As a result of the experiment conducted with the distance from the camera 61 and the object to be imaged set at 1.5 m, most of a skin area such as a hand or arm could be accurately detected with the when the tilt angle θ was set at 3 deg because the luminous quantity index β had a sufficiently great value at that angle although the illuminance ratio variation index α was somewhat great.

As a result of the experiment conducted with the distance from the camera 61 and the object to be imaged set at 1.5 m, the illuminance ratio variation index α had a small value and non-coincidence between illuminance distribution was sufficiently low when the tilt angle θ was set at 46 deg or more. However, the luminous quantity index β also had a small value, and the luminous quantity of the illumination light illuminating the object to be imaged was therefore insufficient. Therefore, the object such as a hand or arm could not be accurately detected in some occasions.

Therefore, the tilt angle θ is set within the range from about 3 deg to about 45 deg in the present embodiment. The distance L is uniquely set (determined) according to the setting of the tilt angle θ.

Thus, the image processing device 41 can accurately detect a skin area such as a hand or arm.

Let us now discuss an optimal value of the tilt angle θ at which a skin area such as a hand or arm can be most accurately detected among the angles in the range from 3 deg to 45 deg that can be set as the tilt angle θ. For example, when the tilt angle 0 is 45 deg, the intensity of illumination light illuminating an object to be imaged decreases about 5% each time the distance from the camera 61 to the object to be imaged changes by 10 cm.

The description has been made on an assumption that an object to be imaged exists in a position 1.5 m apart from the camera 61. In practice, however, an object to be imaged is not necessarily located just 1.5 m apart from the camera 61.

Therefore, in order to detect a skin area of an object to be imaged from a first image obtained by imaging the object even when the object is located, for example, about 10 cm beyond the distance of 1.5 m, it is necessary to maintain the intensity of illumination light (the luminous quantity of illumination light) such that an about 5 to 10 percent difference between reflectances of light rays having the wavelengths λ1 and λ2 can be detected.

As described above, when the tilt angle θ is 45 deg, the intensity of illumination light illuminating an object to be imaged decreases by about 5% each time the distance from the camera 61 to the object to be imaged changes by about 10 cm.

In the case of an object to be imaged located about 10 cm beyond such the distance of 1.5 m, it may be difficult in some occasions to maintain the intensity of the illumination light such that an about 5 to 10 percent difference between reflectances of light rays having the wavelengths λ1 and λ2 can be detected.

For example, when the tilt angle is 34 deg, each time the distance from the camera 61 to an object to be imaged changes by about 10 cm, the intensity of illumination light illuminating the object to be imaged undergoes a decrease that is only about one half of the decrease that occurs when the tilt angle θ is 45 deg.

Therefore, when the tilt angle θ is 34 deg, even in illuminating an object to be imaged located about 10 cm beyond the distance of 1.5 m, the intensity of the illumination light can be kept at such a level that an about 5 to 10 percent difference between reflectances of light rays having the wavelengths λ1 and λ2 can be detected.

Thus, when the distance from the camera 61 to an object to be imaged is 1.5 m, the optimal tilt angle is 34 deg.

As described above, the light source groups 62 (e.g., the light source groups 62A and 62B) of the present embodiment are disposed such that the mechanical axes of the light sources 81 (e.g., the light sources 81A and 81B and the light sources 82 (e.g., the light sources 82A and 82B) are tilted toward the reference axis at the same tilt angle θ. It is therefore possible to suppress non-coincidence between illuminance distributions of light rays having the wavelengths λ1 and λ2.

Therefore, even when the light sources 81 an the light sources 82 are different from each other in directivity, non-coincidence between illuminance distributions of light rays having the wavelengths λ1 and λ2 can be suppressed by tilting the light source groups 62. As a result, the light source groups 62 of the image processing device 41 can be formed in various configurations by combining the light sources 81 and light source 82 appropriately without a need for paying attention to the difference between the light sources 81 and 82 in terms of directivity.

In the present embodiment, since the light source groups 62 are provided in a tilted disposition, an object to be imaged can be illuminated such that less parts of the object will be left unilluminated or shaded, when compared to illumination carried out using light sources disposed, for example, as shown in FIG. 3. Thus, the image processing device 41 can acquire first and second images for detecting a skin area more accurately.

Since the tilted disposition of the light source groups 62 makes it possible to illuminate a greater area of an object to be illuminated, the number of each of the light sources 81 and 82 can be kept as small as two at the minimum (for example, the light sources 81 may be constituted by two light sources, i.e., the light sources 81A and 81B). Thus, the image processing device 41 can be manufactured as a low manufacturing cost.

### 2. Modifications

In the present embodiment, the two light source groups 62A and 62B are provided in a tilted disposition as the light source groups 62. The number and disposition of the light sources 62 is not limited to the above description.

For example, the image processing device 41 may be provided with four light source groups 62.

### Disposition of Four Light Source Groups 62

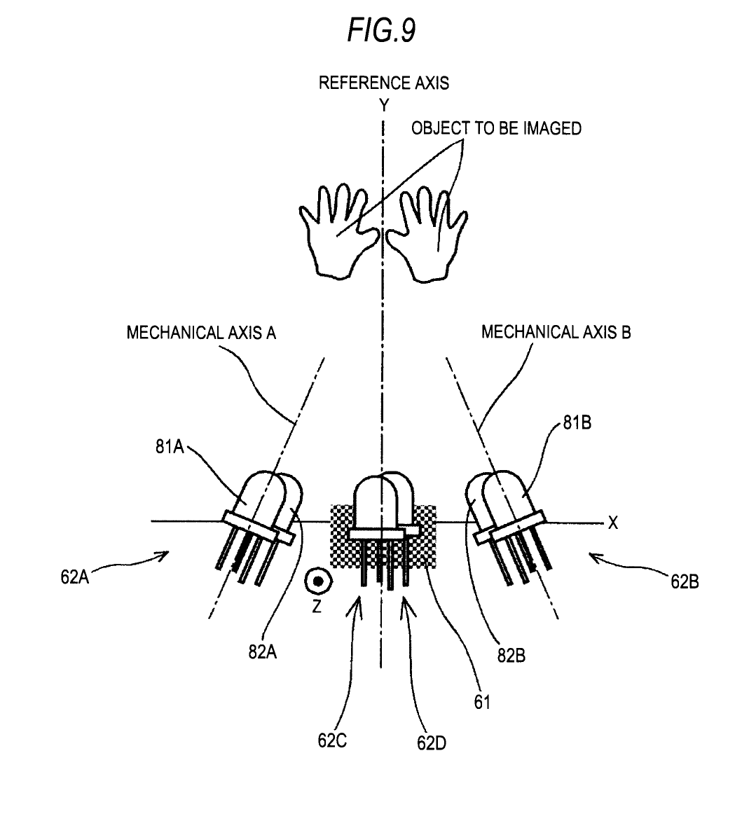

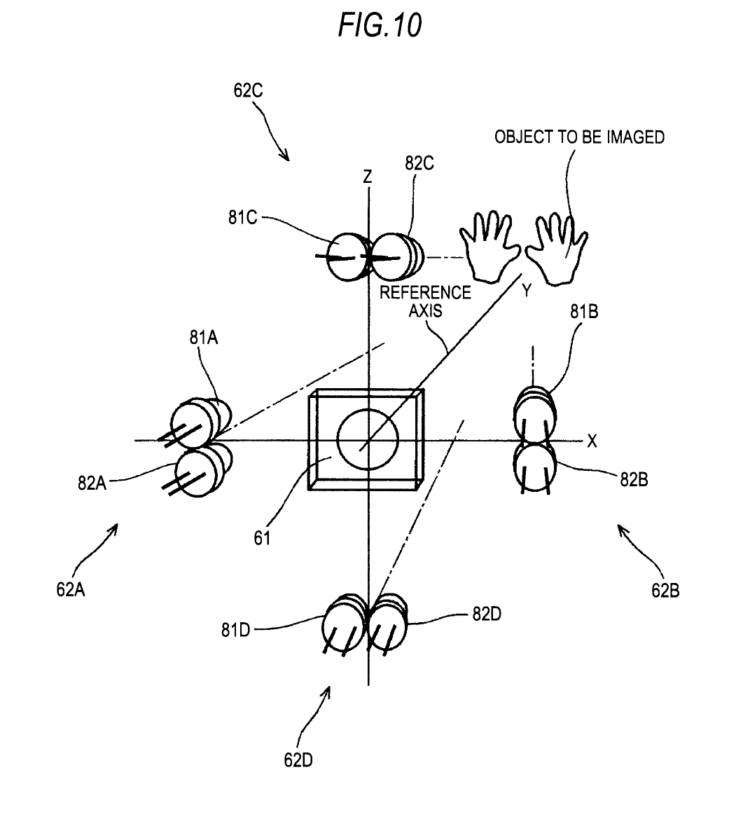

An example of the disposition of four light source groups 62 will now be described with reference to FIGS. 9 and 10.

Elements which are similar in configuration between FIGS. 9 and 5 and between FIGS. 10 and 6 are indicated by like reference numerals, and such elements will not be described below.

FIGS. 9 and 10 show a configuration which is similar to that shown in FIGS. 5 and 6 except that additional light source groups 62C and 62D are provided.

As shown in FIGS. 9 and 10, the light source groups 62C and 62D disposed in positions which are on the Z-axis and in which the light sources are symmetric about the reference axis of the camera 61.

The light source groups 62C and 62D are provided in a tilted disposition in the same manner as the light source groups 62A and 62B.

When the number of the light source groups 62 is increased as thus described, the number of shadows generated on an object to be imaged can be reduced.

In the above-described embodiment, an object to be imaged is illuminated by illumination light from the light source groups 62A and 62B. Alternatively, auxiliary light sources radiating light rays having the wavelengths λ1 and λ2, respectively, may be disposed in positions different from the positions of the light source groups 62A and 62B. Thus, the generation of shadows on an object to be imaged can be suppressed.

For example, the auxiliary light sources may be disposed near the reference axis. However, the degree of coincidence between illuminance distributions is more susceptible to variations of the directivity of the auxiliary light sources, the closer the auxiliary light sources to the reference axis. It is therefore desirable to dispose the auxiliary light sources in positions apart from the reference axis.

In the above-described embodiment, the light sources 81 radiate light having the wavelength λ1 of 870 nm, and the light sources 82 radiate light having the wavelength λ2 of 950 nm. However, the invention is not limited to such a combination of wavelengths.

Any combination of wavelengths may be employed as long as an absolute difference between reflectance of light having the wavelength λ1 and reflectance of light having the wavelength λ2 obtained at the skin of a user is sufficiently greater than an absolute difference between reflectance at other objects.

Specifically, the light sources 81 and 82 may be configured to radiate illumination light having a wavelength λ1 of 930 nm or less and a wavelength λ2 of 930 mm or more, respectively, to use a combination of wavelengths such as a combination of 800 nm and 950 nm, a combination of 870 nm and 1000 nm, or a combination of 800 nm and 1000 nm, instead of the combination of 870 nm and 950 nm.

The embodiment of the invention may be used in an electronic apparatus as a computer which performs processes based on results of the detection of a skin area of an image obtained by imaging an object that is illuminated by illumination light rays having different wavelengths.

The present application contains subject matter related to that disclosed in Japanese Priority Patent Application JP 2009-187047 filed in the Japan Patent Office on Aug. 12, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device detecting a skin area representing the skin of a person from an image obtained by imaging an object, the device comprising:
imaging means for imaging the object;
first illumination means for radiating light having a first wavelength from first and second positions determined based on the position of the imaging means;
second illumination means for radiating light having a second wavelength different from the first wavelength from third and fourth positions determined based on the position of the imaging means; and
detection means for detecting the skin area on either a first image obtained through imaging of the object performed by illuminating the object with the light having the first wavelength or a second image obtained through imaging of the object performed by illuminating the object with the light having the second wavelength.

2. An image processing device according to claim 1, wherein
the first illumination means includes
first output means for radiating light having the first wavelength in the first position, and
second illumination means for radiating light having the first wavelength in the second position; and
each of the first and second output means is tilted toward a reference axis of the imaging means.

3. An image processing device according to claim 2, wherein the first and second output means are provided in a tilted disposition in the first and second positions, respectively, in such a positional relationship that the output means are symmetric about the reference axis of the imaging means.

4. An image processing device according to claim 3, wherein each of the first and second output means is tilted toward the reference axis of the imaging means at a predetermined tilt angle.

5. An image processing device according to claim 4, wherein
either of the first and second output means is provided in the first position in a tilted disposition; and
the other output means is provided in the second position in a tilted disposition, the second position being spaced from the first position at a distance which depends on the predetermined tilt angle.

6. An image processing device according to claim 2, wherein
the second illumination means includes
third output means for radiating light having the second wavelength in third position, and
fourth illumination means for radiating light having the second wavelength in the fourth position; and
each of the third and fourth output means is tilted toward the reference axis of the imaging means.

7. An image processing device according to claim 6, wherein
the first and third output means are provided in the tilted disposition in positions close to each other; and
the second and fourth output means are provided in the tilted disposition in positions close to each other.

8. An image processing device according to claim 1, wherein the first and second illumination means radiate light of the first and second wavelengths set at such values that an absolute difference between the reflectance of reflected light obtained by illuminating the skin of a person with light having the first wavelength and the reflectance of reflected light obtained by illuminating the skin of the person with light having the second wavelength is equal to or greater than a predetermined threshold.

9. An image processing device according to claim 8, wherein the first and second illumination means radiate respective infrared rays having different wavelengths.

10. An image processing device according to claim 9, wherein either of the first and second illumination means radiates light having a wavelength of 930 nm or more, and the other illumination means radiates light having a wavelength less than 930 nm.

11. An image processing method of an image processing device for detecting a skin area representing the skin of a person from an image obtained by imaging an object, including imaging means, first illumination means, second illumination means, and detection means, the method comprising the steps of:
radiating light having a first wavelength from the first illumination means in first and second positions determined based on the position of the imaging means;
radiating light having a second wavelength different from the first wavelength from the second illumination means in third and fourth positions determined based on the position of the imaging means;
imaging the object with the imaging means by illuminating the object with the light having the first wavelength and the light having the second wavelength; and
detecting the skin area on either a first image obtained through the imaging of the object performed by illuminating the object with the light having the first wavelength or a second image obtained through the imaging of the object performed by illuminating the object with the light having the second wavelength.

12. An electronic apparatus detecting a skin area representing the skin of a person from an image obtained by imaging an object, the apparatus comprising:
imaging means for imaging the object;
first illumination means for radiating light having a first wavelength from first and second positions determined based on the position of the imaging means;
second illumination means for radiating light having a second wavelength different from the first wavelength from third and fourth positions determined based on the position of the imaging means;
detection means for detecting the skin area on either a first image obtained through imaging of the object performed by illuminating the object with the light having the first wavelength or a second image obtained through imaging of the object performed by illuminating the object with the light having the second wavelength; and
processing means for performing a process associated with the detected skin area.

13. An image processing device detecting a skin area representing the skin of a person from an image obtained by imaging an object, the device comprising:
an imaging unit configured to image the object;
a first illumination unit configured to radiate light having a first wavelength from first and second positions determined based on the position of the imaging unit;
a second illumination unit configured to radiate light having a second wavelength different from the first wavelength from third and fourth positions determined based on the position of the imaging unit; and
a detection unit configured to detect the skin area on either a first image obtained through imaging of the object performed by illuminating the object with the light having the first wavelength or a second image obtained through imaging of the object performed by illuminating the object with the light having the second wavelength.

14. An electronic apparatus detecting a skin area representing the skin of a person from an image obtained by imaging an object, the apparatus comprising:
an imaging unit configured to image the object;
a first illumination unit configured to radiate light having a first wavelength from first and second positions determined based on the position of the imaging unit;
a second illumination unit configured to radiate light having a second wavelength different from the first wavelength from third and fourth positions determined based on the position of the imaging unit;
a detection unit configured to detect the skin area on either a first image obtained through imaging of the object performed by illuminating the object with the light having the first wavelength or a second image obtained through imaging of the object performed by illuminating the object with the light having the second wavelength; and
a processing unit configured to perform a process associated with the detected skin area.
